(19) United States
(12) Patent Application Publication
(10) Pub. No.: US 2017/0267308 A1
(43) Pub. Date: Sep. 21, 2017

(54) ARRANGEMENT FOR MOUNTING A REAR WHEEL AXLE

(71) Applicant: Carbon Rotec GmbH & Co. KG, Lemwerder (DE)

(72) Inventor: Andreas Geissler, Friesoyte (DE)

(73) Assignee: Carbon Rotec GmbH & Co. KG, Lemwerder (DE)

(21) Appl. No.: 15/447,241

(22) Filed: Mar. 2, 2017

(30) Foreign Application Priority Data
Mar. 15, 2016 (DE) 102016003102.6

(51) Int. Cl. B62K 25/02

(52) U.S. Cl. CPC B62K 25/02

(57) ABSTRACT

An arrangement for mounting a rear wheel axle, having a dropout and a slide which is movable relative to a chain stay. The slide is displaceably arranged within the chain stay, which is hollow in this region, whilst the dropout is provided outside the chain stay and the slide and the dropout are connected to one another through at least one opening in the chain stay.

### STATEMENT OF RELATED APPLICATIONS

This patent application claims the benefit of German Patent Application No. 10 2016 003 102.6 having a filing date of 15 Mar. 2016.

### BACKGROUND OF THE INVENTION

Technical Field

The invention relates to an arrangement for mounting a rear wheel axle, having a dropout and a slide which is movable relative to a chain stay. In addition, the invention relates to a bicycle frame and a bicycle.

Prior Art

In addition to purely human-powered bicycles, the term “bicycle” here also refers to bicycles having a motor or auxiliary motor, electric bicycles and all bicycles with a chain or belt drive, irrespective of the drive power.

A typical bicycle frame has, in its rear region, a substantially horizontal chain stay which is connected at its rear end to a seat stay leading to the saddle tube. A so-called dropout, having an axle mount for the axle of the rear wheel, is provided in the region of the connection between the seat stay and the chain stay. The dropout can be arranged so that it is fixed or adjustable relative to the chain stay. To improve the adaptation of the chain tension or belt tension, a dropout which is adjustable in the longitudinal direction of the bicycle is known, amongst other things.

A dropout which is adjustable in the longitudinal direction is disclosed in CH 700 148 B1 (which corresponds to DE 20 2009 015 815 U1). A slide having a downwardly open axle mount is longitudinally displaceably held and adjustable on the respective chain stay.

Bicycles having frames made of steel are relatively heavy. Bicycles made of light metal are known. Particularly light and high-quality bicycles are also already manufactured using fibre composite materials. Frame parts, such as tubes and stays, made of fibre composite materials have different mechanical load limits compared to frame parts made of steel or light metal. The ability to absorb certain transverse forces is limited whilst forces in the longitudinal direction of the stays or tubes can be absorbed well.

### BRIEF SUMMARY OF THE INVENTION

The object of the present invention is to provide a new arrangement for mounting a rear wheel axle, in particular for a chain stay made of fibre composite material.

To achieve the object, the arrangement according to the invention is an arrangement for mounting a rear wheel axle, having a dropout and a slide which is movable relative to a chain stay, characterized in that the slide is displaceably arranged within the chain stay, which is hollow in this region, in that the dropout is provided outside the chain stay and in that the slide and the dropout are connected to one another through at least one opening in the chain stay. In particular, the slide is displaceably arranged within the chain stay, which is hollow in this region, whilst the dropout is provided outside the chain stay, wherein the slide and the dropout are connected to one another through at least one opening in the chain stay. The axle mount for the rear wheel axle is a component of the dropout. The dropout is held on the slide. As a result of its positioning within the chain stay, the slide can introduce the forces acting on the dropout optimally into the chain stay. An internal cross-section of the chain stay and an external cross-section of the slide are preferably adapted to one another so that the slide is movable in the longitudinal direction within the chain stay with only a small amount of transverse play, if any.

According to a further idea of the invention, at least one connecting member is provided for the in particular releasable connection of the slide and the dropout. The slide and the dropout can thereby be separated from one another during assembly and/or for maintenance purposes. Two or more connecting members are advantageously provided.

According to a further idea of the invention, at least one connecting member is provided for connecting the slide and the dropout in such a way that, in a clamping position, the slide and the dropout are drawn together and lie in particular against a wall of the chain stay. The wall here is clamped between the slide and the dropout so that the slide and the dropout are no longer movable. Two or more connecting members are preferably provided, in particular next to one another in the longitudinal direction of the slide.

According to a further idea of the invention, the chain stay has at least one opening, preferably an elongated hole for the connecting member(s) to pass through. In particular, two successive elongated holes in the longitudinal direction and two connecting members are provided.

According to a further idea of the invention, a screw is provided as a connecting member, in particular with a (vertical) thread in the slide and a bore in the dropout for the screw to pass through. This enables simple fixing of the slide and the dropout in the said clamping position.

According to a further idea of the invention, a retaining piece is provided at the free end of the chain stay, wherein the retaining piece is connected to the slide in particular by an adjusting member. The retaining piece can secure the position of the slide in the chain stay or facilitate positioning.

According to a further idea of the invention, the retaining piece is a cover plate and reaches, in particular with a sub-region, into the end of the chain stay. The cover plate covers the free end of the chain stay and thus protects against the penetration of dirt.

According to a further idea of the invention, the adjusting member for the slide is an adjusting screw which is seated in a horizontal thread of the slide and passes through a bore in the retaining piece. The thread is directed horizontally, i.e. aligned in the longitudinal direction. A head of the adjusting screw lies externally on the retaining piece and can be turned there by a suitable tool.

According to a further idea of the invention, the retaining piece and the free end of the chain stay are designed to be compatible with one another so that the retaining piece may be pushed onto the free end or at least partially inserted into the free end. This facilitates assembly and also improves the introduction of forces at the free end of the chain stay.

According to a further idea of the invention, the retaining piece, or a sub-region thereof, and the free end engage in one another in such a way, and are designed in such a way, that they are not rotatable relative to one another. In particular, the free end and the retaining piece have mutually compatible polygonal cross-sections, for example trapezoidal cross-sections. The dimensions are also compatible with one another so that the retaining piece and the free end engage in one another virtually without play. This also improves the introduction of forces into the free end.

According to a further idea of the invention, the retaining piece is secured against rotation or release, in particular on the chain stay or an adjacent stay, by a retaining member. The assembly of the retaining piece is thereby facilitated. The retaining piece can be initially secured on a stay by the retaining member before a connection to the slide is produced by the adjusting member.

According to a further idea of the invention, the retaining member is a retaining screw which passes through a bore in the retaining piece. A thread for receiving the retaining screw is provided in the material of the chain stay or another stay or in a transition region of the stay.

According to a further idea of the invention, the dropout is provided with a brake mount. The dropout then contains the axle mount and the brake mount. A correct position of the brake with respect to the axle is thereby permanently ensured, even upon an adjustment of the dropout relative to the frame.

According to a further idea of the invention, the dropout is provided with a kickstand mount, in particular with a supporting face and at least one bore. A bicycle kickstand is thus connected to the dropout and not directly to the stays or tubes of the frame. This also improves the introduction of forces into the frame.

According to a further idea of the invention, the slide is provided with at least one bore corresponding to a bore in the kickstand mount. The bore in the slide is in particular designed as an internal thread. Two bores or internal threads are preferably provided at this point.

According to a further idea of the invention, the chain stay has at least one opening, preferably an elongated hole for a connecting member for connecting the slide and the kickstand mount to pass through. Another part of the dropout can be held here between the kickstand mount and the chain stay. At least one screw, which is held for example in an internal thread of the slide, is preferably provided as a connecting member.

According to a further idea of the invention, the dropout and/or the slide are made of metal, in particular light metal. The chain stay can be made of fibre composite material, at least the region provided for connection to the dropout. The chain stay can alternatively be manufactured from metal or another material.

The object of the invention is also a bicycle frame, in particular with a chain stay made of fibre composite material, having an arrangement described above. The bicycle frame can also be made entirely, or predominantly, of metal.

The object of the invention is finally also a bicycle with a bicycle frame as described above, in particular with a chain stay made of fibre composite material, having an arrangement according to the embodiments above.

### BRIEF DESCRIPTION OF THE DRAWINGS

Further features of the invention are revealed moreover in the description and in the claims. Advantageous embodiments of the invention are explained in more detail below with reference to drawings, which show:

FIG. 1 is an exploded illustration of a dropout for connection to a chain stay on the right-hand side of a bicycle;

FIG. 2 is a dropout for a chain stay on the left-hand side;

FIG. 3 is a longitudinal section through part of the arrangement according to FIG. 2.

### DETAILED DESCRIPTION OF PREFERRED EMBODIMENTS

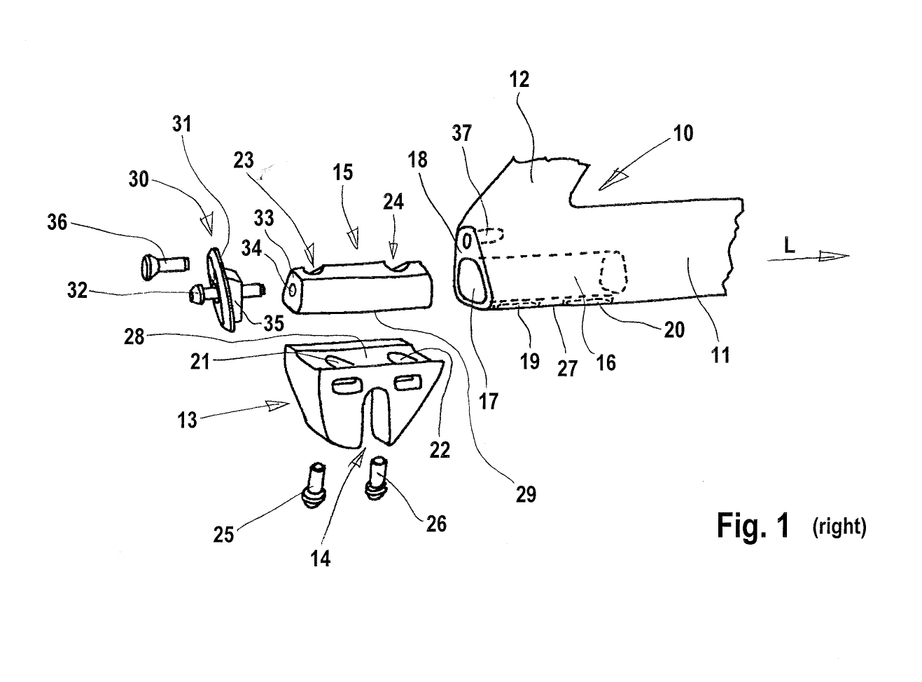

Reference is first of all made to FIG. 1. This shows a connecting region 10 of the chain stay 11 and seat stay 12 of a bicycle (not illustrated in more detail), namely on the right-hand side of the bicycle. A dropout 13 having a downwardly directed axle mount 14 is associated with the connecting region 10. The dropout 13 is connected in a clamping manner to the chain stay 11 in the connecting region 10. To this end, a slide 15 is provided, which may be slid in the longitudinal direction L into a compatible mount 16 of the chain stay. The chain stay 11 is designed to be hollow, at least in this region, on account of the mount 16. An opening 17 in the mount 16 is surrounded by a supporting face 18. The opening 17 and the supporting face 18 form an end face of the chain stay 11.

The chain stay 11 has two elongated holes 19, 20 below the mount 16. Corresponding to these, the dropout 13 has two vertically directed bores 21, 22. The slide 15 is provided accordingly with two internal threads 23, 24 which serve to receive retaining screws 25, 26. The threads thereof are guided from below through the bores 21, 22 and through the elongated holes 19, 20 into the internal threads 23, 24 and screwed in place there. Screw heads of the retaining screws 25, 26 effect a clamping seat of the dropout 13 and the slide 15 on a lower side 27 of the chain stay 11. For a uniform distribution of the forces, an upper side 28 of the dropout 13 and a lower side 29 of the slide 15 are adapted to the contour of the chain stay 11 and the mount 16 respectively in this region.

The dropout 13 and the slide 15 are preferably made of a metal material, whilst the chain stay 11 or the connecting region 10 is preferably manufactured from a fibre composite material.

The slide 15 is to be guided into the chain stay 11 from behind, i.e. through the opening 17. When the rear wheel, which is moved by a chain drive or belt drive, is inserted into the axle mount 14, a tension force is produced in the longitudinal direction L. A precise adjustment to the position of the slide 15 in the mount 16 is expedient. To this end, a cover plate 30 is provided, which comes to lie with a peripheral edge 31 on the supporting face 18 and is provided with a bore for an adjusting screw 32. The slide 15 has, at its end face 33, an internal thread 34 for receiving a thread of the adjusting screw 32. A head of the adjusting screw 32 lies externally on the cover plate 30.

The cover plate 30 is provided with a raised portion 35 within the peripheral edge 31, which raised portion is directed into the mount 16. The external contour of the raised portion is adapted to the internal contour of the mount 16. Cross-sections of the external contour and internal contour are configured to be substantially polygonal, preferably trapezoidal, as is the cross-section of the slide 15. Rotational movements are thereby virtually impossible.

A retaining screw 36 is provided as an additional anti-rotation means and as an assembly aid, the thread of which retaining screw is screwed into an internal thread 37 in the supporting face 18 through a bore in the peripheral edge 31. The internal thread 37 here is provided above the opening 17.

When assembling the dropout 13 on the chain stay 11, the slide 15 is initially slid into the mount 16 until the internal threads 23, 24 are positioned over the elongated holes 19, 20. The dropout 13 is then held against the elongated holes 19, 20 from below and the retaining screws 25, 26 are pushed through the bores 21, 22 and tightened until a loose connection is produced between the slide 15 and the dropout 13. The cover plate 30 is then placed on the opening 17 and the retaining screw 36 is screwed into the internal thread 37. The adjusting screw 32 is subsequently screwed into the internal thread 34. With this, the position of the slide 15 and the dropout 13 alters until a desired position is reached. Finally, the retaining screws 25, 26 are firmly tightened, preferably with a predetermined controlled torque.

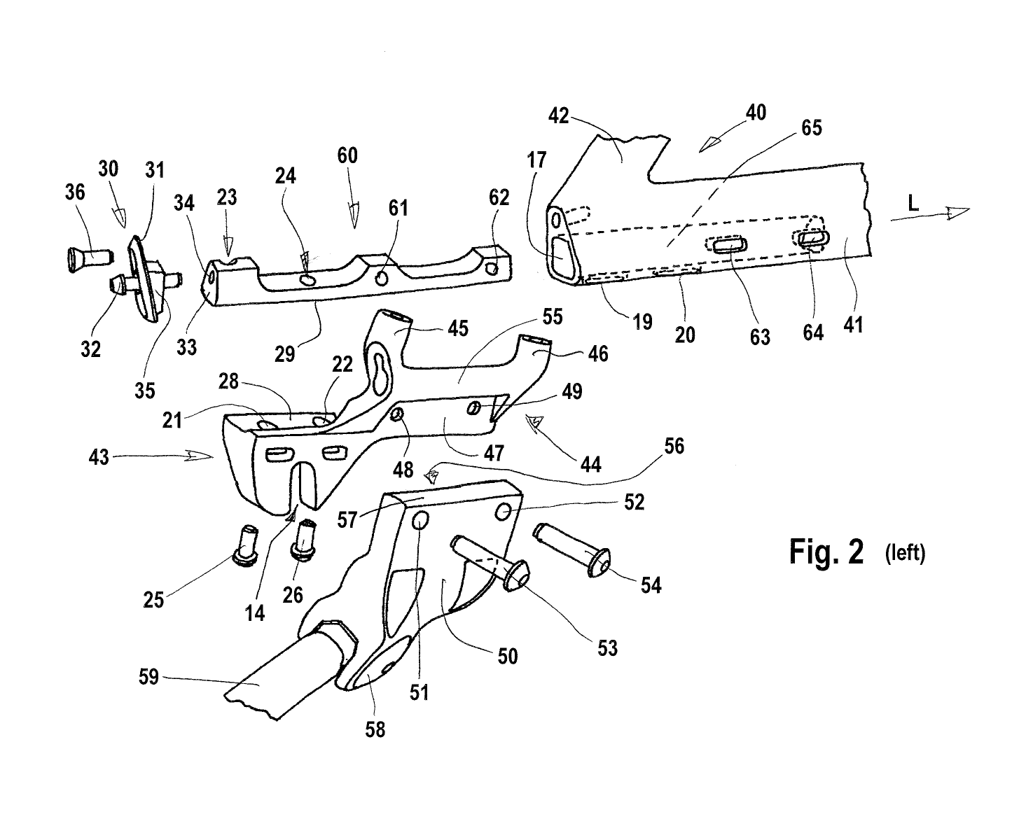

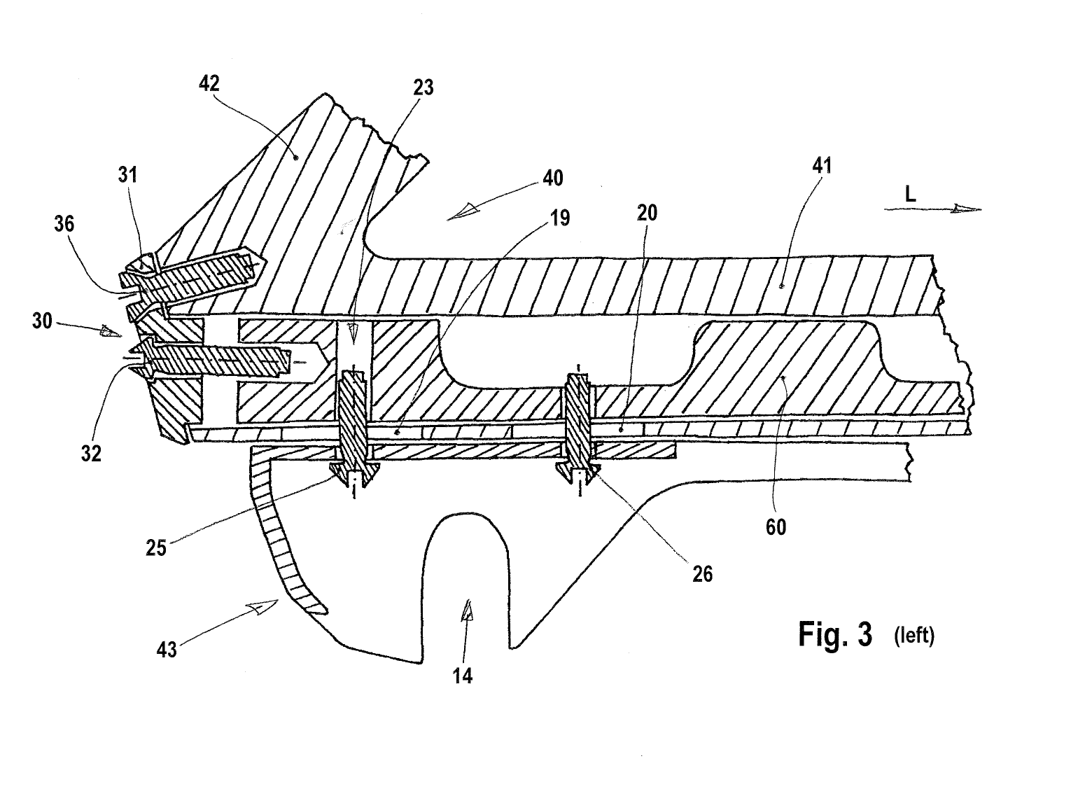

FIGS. 2 and 3 show a left-hand side connecting region 40 with a chain stay 41 and a seat stay 42. Where expedient, the reference numerals used are the same as in FIG. 1. A dropout 43 is configured in the same manner as the dropout 13, but with additional functions and has, adjacent to the upper side 28, a projection 44 which is directed substantially upwards and in the longitudinal direction L. The projection 44 contains two upwardly directed connecting pieces 45, 46 as brake mounts for a brake calliper (not shown) of a disc brake, and a supporting face 47 having bores 48, 49 for supporting and fastening a kickstand head 50. This latter is designed to be substantially plate-shaped, with two bores 51, 52 which are adjacent to one another and correspond to the bores 48, 49 for retaining screws 53, 54 to pass through.

The supporting face 47 is provided below or between the connecting pieces 45, 46. The connecting pieces 45, 46 can be part of a U-shaped configuration with a base 55. The connecting pieces 45, 46 can also continue a short distance downwards and, at the same time, laterally alongside the supporting face 47 to produce an overall H-shaped configuration with the base 55 in the centre.

The kickstand head 50 has a supporting face 56 (concealed in FIG. 2) corresponding to the supporting face 47. An upper end face 57 of the kickstand head 50 can lie against a lower side of the base 55, which delimits the supporting face 47 at the top. A kickstand 59 adjoins the kickstand head 50 at the bottom by means of a joint 58.

In the exemplary embodiment of FIGS. 2, 3, a slide 60 is also designed in a particular manner in addition to the dropout 43. This slide is approximately twice as long here as the slide 15 in FIG. 1 and is provided with two additional internal threads 61, 62 which are provided for receiving the retaining screws 53, 54 and are arranged accordingly laterally. Compatible with this, the chain stay 41 has, laterally, two additional elongated holes 63, 64 in front of the downwardly directed elongated holes 19, 20 in the longitudinal direction L. A mount 65 in the chain stay 41 is adapted to the longer length of the slide 60. Fully assembled, the slide 60 therefore has at least two screw connections, namely to the dropout 43 and the upper side 28 thereof at the bottom and to the kickstand head 50 through the supporting face 47 at the side. The projection 44 has, on the rear side of the supporting face 47, a supporting face which is not visible and which is adapted to the external contour of the chain stay 41 in this region.

The slide 60 is designed to be as flat as possible for weight reasons. The slide 60 is designed with a somewhat thicker cross-section only in the region of the adjusting screw 32, the retaining screw 25 and the retaining screws 53, 54 and, in FIG. 2, accordingly has three raised portions and two depressions on its upper side.

The assembly of the dropout 43 on the left-hand side takes place in a similar manner to the assembly of the dropout 13 on the right-hand side. In addition, the retaining screws 53, 54 are initially only loosely inserted. The retaining screws 53, 54 are only firmly tightened once positioning has taken place by means of the adjusting screw 32.

### LIST OF REFERENCE SIGNS

10 Connecting region
11 Chain stay
12 Seat stay

### 13 Dropout

14 Axle mount

### 15 Slide

### 16 Mount

### 17 Opening

18 Supporting face
19 Elongated hole
20 Elongated hole

### 21 Bore

### 22 Bore

23 Internal thread
24 Internal thread
25 Retaining screw
26 Retaining screw
27 Lower side
28 Upper side
29 Lower side
30 Cover plate
31 Peripheral edge
32 Adjusting screw
33 End face
34 Internal thread
35 Raised portion
36 Retaining screw
37 Internal thread
38
39
40 Connecting region
41 Chain stay
42 Seat stay

### 43 Dropout

### 44 Projection

45 Connecting piece
46 Connecting piece
47 Supporting face

### 48 Bore

### 49 Bore

50 Kickstand head

### 51 Bore

### 52 Bore

53 Retaining screw
54 Retaining screw

### 55 Base

56 Supporting face
57 End face

### 58 Joint

### 59 Kickstand

### 60 Slide

61 Internal thread
62 Internal thread
63 Elongated hole
64 Elongated hole

### 65 Mount

L Longitudinal direction

What is claimed is:

1. An arrangement for mounting a rear wheel axle, comprising a dropout (13, 43) and a slide (15, 60) which is movable relative to a chain stay (11, 41), wherein:
the slide (15, 60) is displaceably arranged within the chain stay (11, 41), which is hollow in this region;
the dropout (13, 43) is provided outside the chain stay; and
the slide (15, 60) and the dropout (13, 43) are connected to one another through at least one opening in the chain stay (11, 41).

2. The arrangement according to claim 1, further comprising at least one connecting member for the in particular releasable connection of the slide (15, 60) and the dropout (13, 43).

3. The arrangement according to claim 1, further comprising at least one connecting member for connecting the slide (15, 60) and the dropout (13, 43) in such a way that, in a clamping position, the slide (15, 60) and the dropout (13, 43) are drawn together and lie in particular against a wall of the chain stay (11, 41).

4. The arrangement according to claim 2, wherein the chain stay (11, 41) has at least one opening, preferably an elongated hole (19, 20) for the connecting member to pass through.

5. The arrangement according to claim 2, further comprising a screw (25, 26) provided as a connecting member, in particular with an internal thread (23, 24) in the slide, and a bore (21, 22) in the dropout (13, 43) for the screw (25, 26) to pass through.

6. The arrangement according to claim 1, further comprising a retaining piece at a free end of the chain stay (11, 41), wherein the retaining piece is connected to the slide (15, 60) in particular by an adjusting member.

7. The arrangement according to claim 6, wherein the retaining piece is a cover plate (30) and reaches, in particular with a sub-region (raised portion 35), into the end of the chain stay (11, 41).

8. The arrangement according to claim 6, wherein the adjusting member is an adjusting screw (32) which is seated in a horizontal/longitudinally directed thread (34) of the slide (15, 60) and passes through a bore in the retaining piece.

9. The arrangement according to claim 6, wherein the retaining piece and the free end of the chain stay (11, 41) are designed to be compatible with one another so that the retaining piece may be pushed onto the free end or at least partially inserted into the free end.

10. The arrangement according to claim 6, wherein the retaining piece and the free end engage in one another in such a way, and are designed in such a way, that they are not rotatable relative to one another.

11. The arrangement according to claim 6, wherein the retaining piece is secured against rotation or release, in particular on the chain stay (11, 41) or an adjacent stay (seat stay 12, 42), by a retaining member.

12. The arrangement according to claim 11, wherein the retaining member is a retaining screw (36) which passes through a bore in the retaining piece.

13. The arrangement according to claim 1, wherein the dropout (13, 43) is provided with a brake mount.

14. The arrangement according to claim 1, wherein the dropout (13, 43) is provided with a kickstand mount, in particular with a supporting face (47) and at least one bore (49, 49).

15. The arrangement according to claim 14, wherein the slide (60) is provided with at least one bore (61, 62) corresponding to a bore (48, 49).

16. The arrangement according to claim 14, wherein the chain stay (41) has at least one opening, preferably an elongated hole (63, 64) for a connecting member for connecting the slide (60) and the kickstand mount to pass through.

17. The arrangement according to claim 1, wherein the dropout (13, 43) and/or the slide (15, 60) are made of metal, in particular light metal.

18. A bicycle frame, in particular with a chain stay (11, 41) made of fibre composite material, having an arrangement for mounting a rear wheel axle, the arrangement comprising a dropout (13, 43) and a slide (15, 60) which is movable relative to a chain stay (11, 41), wherein:
the slide (15, 60) is displaceably arranged within the chain stay (11, 41), which is hollow in this region;
the dropout (13, 43) is provided outside the chain stay; and
the slide (15, 60) and the dropout (13, 43) are connected to one another through at least one opening in the chain stay (11, 41).

19. A bicycle, in particular with a chain stay (11, 41) made of fibre composite material, having an arrangement for mounting a rear wheel axle, the arrangement comprising a dropout (13, 43) and a slide (15, 60) which is movable relative to a chain stay (11, 41), wherein:
the slide (15, 60) is displaceably arranged within the chain stay (11, 41), which is hollow in this region;
the dropout (13, 43) is provided outside the chain stay; and
the slide (15, 60) and the dropout (13, 43) are connected to one another through at least one opening in the chain stay (11, 41).
